(19) United States
(12) Patent Application Publication
(10) Pub. No.: US 2015/0357864 A1
(43) Pub. Date: Dec. 10, 2015

(54) POWER SOURCE SWITCHING APPARATUS AND METHODS FOR DUAL-POWERED ELECTRONIC DEVICES

(71) Applicant: Bayer Healthcare LLC, Whippany, NJ (US)

(72) Inventor: Igor Y. Gofman, Croton-on-Hudson, NY (US)

(21) Appl. No.: 14/298,528

(22) Filed: Jun. 6, 2014

(51) Int. Cl. H02J 9/06; H02J 7/00

(52) U.S. Cl. CPC H02J 9/061; H02J 7/0063

(57) ABSTRACT

A power source switching circuit for a dual-powered electronic device can provide improved battery utilization by allowing a lower range of battery voltages to be used without causing the electronic device to reset when the device is switched from an external power source to a non-rechargeable battery power source. The power source switching circuit can prevent a transient voltage drop that can occur during such power source transitions. A comparator can control the operation of a switch that connects and disconnects the non-rechargeable battery power source to the load of the electronic device such that the system voltage provided to the load remains above a reset voltage threshold during transitions from the external power source to the non-rechargeable battery power source. Methods of providing a power source switching circuit for dual-powered electronic devices are also provided, as are other aspects.

### FIELD

The invention relates generally to electronic devices that can be powered by either battery power or external power.

### BACKGROUND

Some electronic devices, such as, e.g., blood glucose meters, can be powered by either the device's non-rechargeable battery source or an external power source connected to the device via, e.g., a USB (universal serial bus) cable. Such electronic devices typically have a power source switching circuit that disconnects the non-rechargeable battery source from the device's circuitry when the device is powered by the external power source. This can prevent the non-rechargeable battery source from receiving power from the external power source, which can damage the non-rechargeable battery source. When a user unplugs the USB cable from the external power source or the electronic device, causing the electronic device to switch from the external power source back to the non-rechargeable battery source, a transient voltage drop may occur as the power source switching circuit reconnects the non-rechargeable battery source to the device's circuitry. This transient voltage drop can cause the electronic device's circuitry to undesirably reset. For example, a real-time clock in a blood glucose meter, which users may rely upon for taking timely blood glucose measurements, can undesirably reset to, e.g., “12:00” during such a power source transition. To prevent such a reset, some known electronic devices limit operation of the device to an upper voltage range of the non-rechargeable battery source. This, however, can result in poor battery utilization, which can require more frequent replacement of the device's batteries.

A need therefore exists to provide dual-powered electronic devices with power source switching apparatus and methods that can provide improved battery utilization while preventing transient voltage drops that can cause an electronic device to reset when power is switched from an external power source to a non-rechargeable battery power source.

### SUMMARY

According to one aspect, a power source switching circuit is provided. The power source switching circuit comprises a first power source input node; a system power node coupled to the first power source input node; a second power source input node; an FET (field effect transistor) having a gate, a drain, and a source, the drain coupled to the second power source input node, and the source coupled to the system power node; a voltage divider having an input and an output, the input coupled to the first power source input node; and a comparator having an output, a first input, and a second input, the output of the comparator coupled to the gate of the FET, the first input coupled to the output of the voltage divider, and the second input coupled to the second power source input node; wherein the FET is configured to be in a non-conductive state in response to the first power source input node receiving an operating voltage from an external power source, and in a conductive state in response to the first power source input node not receiving the operating voltage from the external power source.

According to another aspect, a dual-powered biosensor meter is provided. The biosensor meter comprises a USB (universal serial bus) connector; a battery connector; a microcontroller configured to receive power via the USB connector or the battery connector but not both concurrently, the microcontroller configured to determine a property of an analyte in a fluid; and a power source switching circuit comprising a first power source input node coupled to the USB connector; a system power node coupled to the first power source input node and to the microcontroller; a second power source input node coupled to the battery connector; a switch coupled between the second power source input node and the system power node; and a comparator configured to control the switch and having an output, a first input, and a second input, the output of the comparator coupled to the switch, the first input coupled to the first power source input node, and the second input coupled to the second power source input node; wherein the switch is configured to be open in response to the first power source input node receiving an operating voltage from an external power source via the USB connector, and closed in response to the first power source input node not receiving the operating voltage from the external power source; and wherein a voltage at the system power node maintains a voltage level above a reset voltage threshold during a transition from the first power source input node receiving the operating voltage to the first power source input node not receiving the operating voltage.

According to a further aspect, a method of providing a power source switching circuit for a dual-powered electronic device is provided. The method comprises coupling a first power source input node of the power source switching circuit to an external power source connector of the dual-powered electronic device; coupling a second power source input node of the power source switching circuit to a battery connector of the dual-powered electronic device; coupling a power source switch between the second power source input node and a system power node of the dual-powered electronic device; and coupling an output of a comparator to the power source switch such that the comparator controls the connect and disconnect operation of the power source switch, wherein the comparator is configured to cause the power source switch to conductively connect the second power source input node to the system power node such that a voltage at the system power node maintains a voltage level above a reset voltage threshold of the dual-powered electronic device during a transition from the first power source input node receiving an operating voltage via the external power source connector to the first power source input node not receiving the operating voltage.

Still other aspects, features, and advantages of the invention may be readily apparent from the following detailed description wherein a number of example embodiments and implementations are described and illustrated, including the best mode contemplated for carrying out the invention. The invention may also include other and different embodiments, and its several details may be modified in various respects, all without departing from the scope of the invention. Accordingly, the drawings and descriptions are to be regarded as illustrative in nature, and not as restrictive. The invention covers all modifications, equivalents, and alternatives falling within the scope of the invention.

### BRIEF DESCRIPTION OF DRAWINGS

Persons skilled in the art will understand that the drawings, described below, are for illustrative purposes only. The drawings are not necessarily drawn to scale and are not intended to limit the scope of this disclosure in any way.

FIG. 1 illustrates an example schematic diagram of a power source switching circuit of a dual-powered electronic device according to the prior art.

FIGS. 2A, 2B, and 2C illustrate graphs of various voltages of a dual-powered electronic device versus time according to the prior art.

FIG. 2D illustrates a graph of an enlarged section D of FIG. 2C.

FIG. 3 illustrates a schematic diagram of a power source switching circuit of a dual-powered electronic device according to embodiments.

FIGS. 4A, 4B, 4C, and 4D illustrate graphs of various voltages of a dual-powered electronic device versus time according to embodiments.

FIG. 5 illustrates a flowchart of a method of providing a power source switching circuit for a dual-powered electronic device according to embodiments.

### DETAILED DESCRIPTION

Reference will now be made in detail to the example embodiments of this disclosure, which are illustrated in the accompanying drawings. Wherever possible, the same reference numbers will be used throughout the drawings to refer to the same or like parts.

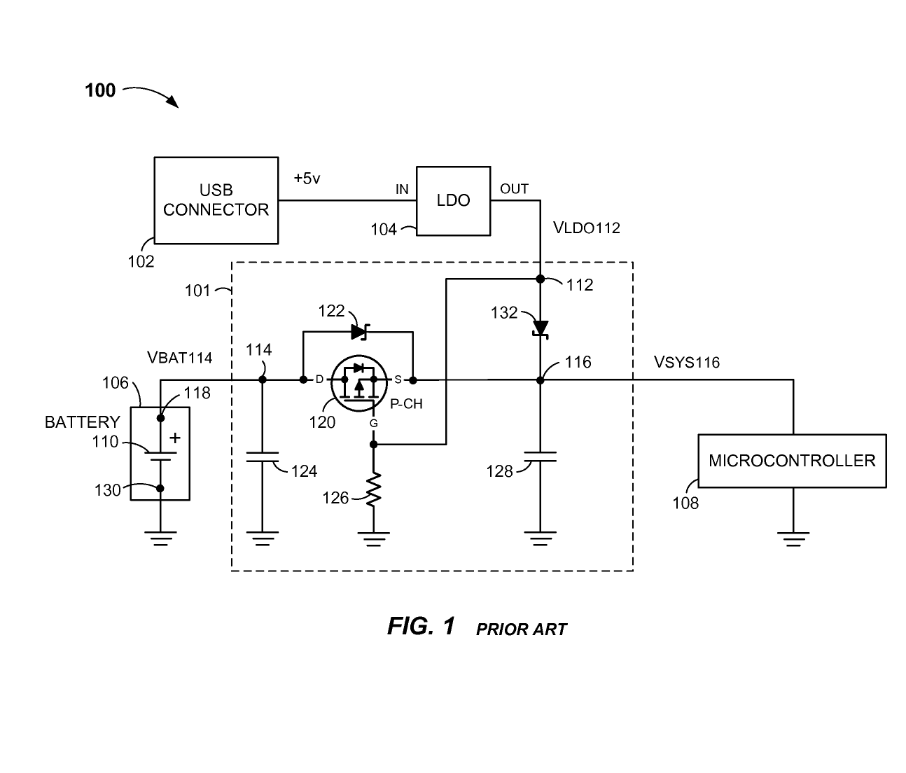

In one aspect, a power source switching circuit can provide a dual-powered electronic device with improved battery utilization by allowing the device to operate with a lower range of usable battery voltages without causing the electronic device to reset. An electronic device may reset if its system voltage drops to a reset voltage threshold. In some known dual-powered electronic devices with a non-rechargeable battery power source, a transient voltage drop sufficient to cause a reset may occur as the device is switched from an external power source to its non-rechargeable battery power source. The power source switching circuit can mitigate, if not prevent, transient voltage drops during such power source transitions. In some embodiments, the power source switching circuit can be configured with no additional hardware. That is, the power source switching circuit can be configured with the same circuit components commonly used in known power source switching circuits and with at least one other component commonly available for use in many electronic devices, as described in more detail below. In some embodiments, the power source switching circuit can be configured to provide a system voltage to the load (i.e., the circuitry of the electronic device) sufficiently high to avoid reset wherein the power from only one of the external power source or the non-rechargeable battery power source is needed at any one time. In other words, power from both the external power source and the non-rechargeable battery power source are not needed concurrently to avoid reset and/or improve battery utilization. In some embodiments, the power source switching circuit may be referred to as a battery disconnect switch. The dual-powered electronic device may be, e.g., a biosensor meter, and more particularly, e.g., a blood glucose meter. In some embodiments, improved battery utilization provided by the power source switching circuit can result in about 160-200 additional blood glucose measurements in a blood glucose meter having a Li—Mn (lithium-manganese) battery power source (e.g., one or more CR2032 coin cell batteries). In other aspects, methods of providing a power source switching circuit for dual-powered electronic devices are provided, as will be explained in greater detail below in connection with FIGS. 1-5.

FIG. 1 illustrates a dual-powered electronic device 100 that includes an example power source switching circuit 101 in accordance with the prior art. Power source switching circuit 101 can be an integral part of dual-powered electronic device 100 or alternatively can be constructed with one or more discrete components. Dual-powered electronic device 100 can include a USB (universal serial bus) connector 102, a low dropout voltage regulator 104, a battery connector 106, and a microcontroller 108. Battery connector 106 can be configured to connect to a non-rechargeable battery power source 110, which can include one or more non-rechargeable batteries. The non-rechargeable batteries typically can be Li—Mn type batteries. Dual-powered electronic device 100 can include other circuitry (not shown) configured to perform various functions, such as, e.g., input/output, display, memory, and/or additional processing not provided by microcontroller 108. Dual-powered electronic device 100 can be, e.g., a biosensor meter, and more particularly a blood glucose meter. Alternatively, dual-powered electronic device 100 can be any other suitable dual-powered electronic device.

Power source switching circuit 101 can include a first power source input node 112, a second power source input node 114, and a system power node 116. First power source input node 112 can be coupled to USB connector 102 via low dropout voltage regulator 104 coupled there between. Second power source input node 114 can be coupled to a positive terminal 118 of battery connector 106, and system power node 116 can be coupled to the load (i.e., microcontroller 108 and other possible circuitry (not shown)) of electronic device 100. Power source switching circuit 101 can also include a P-channel MOSFET 120 having a drain D, a source S, and a gate G. The drain D can be coupled to second power source input node 114. The source S can be coupled to system power node 116, and the gate G can be coupled to first power source input node 112. A bypass Schottky diode 122 can be coupled across P-channel MOSFET 120 as shown, wherein the anode of diode 122 can be coupled to second power source input node 114 and the cathode of diode 122 can be coupled to system power node 116. Power source switching circuit 101 can further include a first capacitor 124, a pull-down resistor 126, and a second capacitor 128. First capacitor 124 can be coupled between second power source input node 114 and ground (i.e., a negative terminal 130 of battery connector 106). Pull-down resistor 126 can be coupled between the gate G of P-channel MOSFET 120 and ground, and second capacitor 128 can be coupled between system power node 116 and ground. A Schottky diode 132 can be coupled between first power source input node 112 and system power node 116 as shown, wherein the anode of diode 132 can be coupled to first power source input node 112 and the cathode of diode 132 can be coupled to system power node 116.

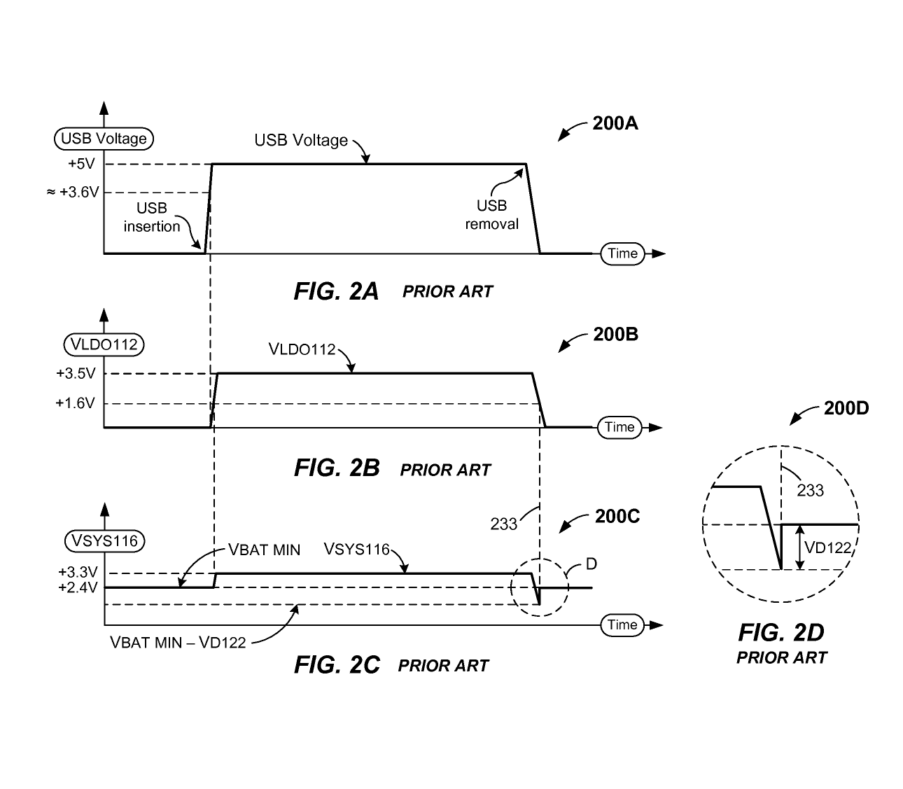

FIGS. 2A-D illustrate graphs of various voltages of dual-powered electronic device 100 versus time in accordance with the prior art. In particular, FIG. 2A illustrates a waveform 200A of a USB voltage received at USB connector 102 from an external power source. FIG. 2B illustrates a corresponding waveform 200B of a voltage (VLDO112) at first power source input node 112 received from the output of low dropout voltage regulator 104. And FIGS. 2C and 2D illustrate waveforms 200C and 200D, respectively, of a corresponding system voltage (VSYS116) at system power node 116.

In standalone mode, wherein USB connector 102 is not coupled to an external power source (i.e., VLDO112 at first power source input node 112 can be at or about zero volts), the gate G of P-channel MOSFET 120 can be held at ground level by pull-down resistor 126. This can maintain P-channel MOSFET 120 in a conductive state (i.e., P-channel MOSFET 120 is “ON”). Non-rechargeable battery power source 110 via battery connector 106 is thus electrically connected to system power node 116 via P-channel MOSFET 120 and, because P-channel MOSFET 120 can have very low DC resistance, VBAT114=VSYS116 at second power source input node 114 and system power node 116, respectively. Accordingly, non-rechargeable battery power source 110 can provide power in standalone mode to the load (i.e., circuitry including at least microcontroller 108), which is coupled to system power node 116 of dual-powered electronic device 100.

Upon a user plugging one end of a USB cable into USB connector 102 and the other end into a USB port (of, e.g., a personal computer or suitable converter connected to a power outlet), a USB voltage of typically about 5 volts can be received at the input of low dropout voltage regulator 104, as shown shortly after “USB insertion” in FIG. 2A. Low dropout voltage regulator 104 can typically generate an output voltage (VLDO112) of about 3.5 volts at first power source input node 112, as shown in FIG. 2B. The resulting voltage at system power node 116 can be:

VSYS116=VLDO112−VD132

wherein VD132 is the forward voltage drop of diode 132. For a Schottky diode, the forward voltage drop typically can be about 0.3 volts. Thus, the system voltage VSYS116 at system power node 116 can be about 3.3 volts, as shown in FIG. 2C, which is a common voltage for USB enabled electronic devices.

To prevent damage to non-rechargeable battery power source 110 from power received via USB connector 102, power source switching circuit 101 can be configured to electrically disconnect battery connector 106 and non-rechargeable battery power source 110 from system power node 116. Upon the coupling of USB connector 102 to an external power source, the voltage at gate G of P-channel MOSFET 120 can rise to the generated output voltage VLDO112, which can be about 3.5 volts as described above. Concurrently, the voltage at source S of P-channel MOSFET 120 can be about 3.3 volts (i.e., VSYS116 at system power node 116; see FIG. 2C). This can cause the gate-to-source voltage of P-channel MOSFET 120 to be reversed biased, which can drive P-channel MOSFET 120 into a non-conductive state (i.e., P-channel MOSFET 120 can turn “OFF”), which electrically disconnects battery connector 106 and non-rechargeable battery power source 110 from system power node 116.

Upon removing the USB cable from the USB port and/or USB connector 102, the USB voltage can begin to drop as shown immediately after “USB removal” in FIG. 2A. In response to the USB voltage dropping below the minimum rated input voltage for low dropout voltage regulator 104 (which typically can be about 3.6 volts), VLDO112 can also begin to drop as shown in FIG. 2B, which can cause VSYS116 to drop as shown in FIGS. 2C and 2D. To prevent dual-powered electronic device 100 from resetting, VSYS116 should not drop below a reset voltage threshold, wherein a typical “brown-out” reset voltage threshold can be about 1.8 volts. In response to VSYS116 dropping below VBAT114−VD122, wherein VD122 is the forward voltage drop of diode 122 (e.g., about 0.3 volts), diode 122 can start conducting and can maintain VSYS116 at VBAT114−VD122. However, VSYS116 can experience a transient voltage drop at time 233 as shown in section D of FIGS. 2C and 2D that can equal VD122. Therefore, to avoid reset, non-rechargeable battery power source 110 should not be used if its voltage drops below:

VBAT MIN=VRESET+VD122

wherein VBAT MIN is the minimum operating battery voltage that can be used to operate dual-powered electronic device 100, and VRESET is the reset voltage threshold.

The system voltage VSYS116 at system power node 116 should not go below VRESET. Thus, for VRESET=1.8 volts (a typical threshold), the minimum usable battery voltage is VBAT MIN=1.8 volts+0.3 volts=2.1 volts. However, the value of VD122 can vary within a wide range depending on load, temperature, and other conditions. Thus, to provide reliable operation, some known dual-powered electronic devices prohibit device operation (i.e., will force the device to shut down) at battery voltages below about 2.4 volts.

The nominal operating voltage of a non-rechargeable Li—Mn battery power source typically used in dual-powered electronic device 100 can range from about 1.8 volts to about 3.0 volts. Thus, by limiting operation of dual-powered electronic device 100 to battery voltages at or above, e.g., 2.4 volts, to avoid the possible reset of dual-powered electronic device 100, battery utilization can be inefficient. For example, for a non-rechargeable Li—Mn CR2032 coin cell battery driving a typical load of 5 mA, the unused battery capacity can be about 8-10%, which can translate to about 160-200 blood glucose measurements. Thus, the inefficient battery utilization can result in additional expense and inconvenience as batteries need to be replaced more often.

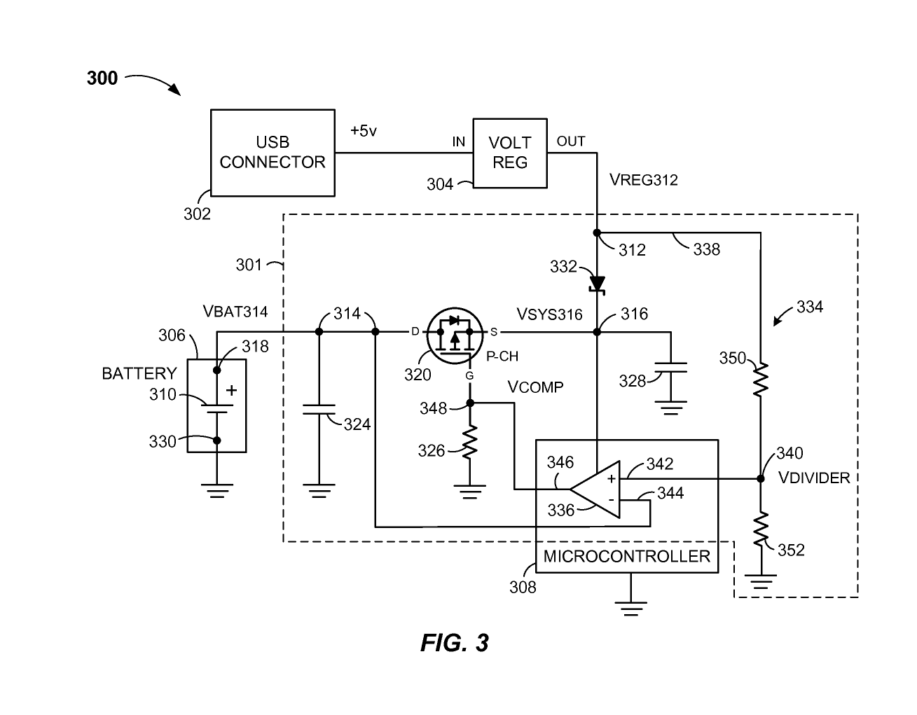

FIG. 3 illustrates a dual-powered electronic device 300 that includes a power source switching circuit 301 in accordance with one or more embodiments. Power source switching circuit 301 can be an integral part of electronic device 300 or alternatively can be constructed with one or more discrete components. Dual-powered electronic device 300 can include a USB (universal serial bus) connector 302, a voltage regulator 304, a battery connector 306, and a microcontroller 308. In some embodiments, USB connector 302, voltage regulator 304, and/or a battery connector 306 can be considered a part of power source switching circuit 301.

USB connector 302 can be configured to receive power from an external power source via a USB cable connected there between. In addition to receiving external power, USB connector 302 can also serve as an input/output interface for data transfer between dual-powered electronic device 300 and another device, such as, e.g., a personal computer. In other embodiments, dual-powered electronic device 300 can include any suitable type of external power source connector instead of USB connector 302.

Battery connector 306 can include a positive terminal 318 and a negative terminal 330. Battery connector 306 can be configured to connect to a non-rechargeable battery power source 310, which can include one or more non-rechargeable batteries. In some embodiments, the non-rechargeable batteries can be Li—Mn (lithium-manganese) type batteries such as, e.g., one or more 3-volt CR2032 coin cell batteries. In other embodiments, the one or more non-rechargeable batteries can be of any suitable type.

In some embodiments, dual-powered electronic device 300 can be, e.g., a biosensor meter and, more particularly, a blood glucose meter. In those embodiments, microcontroller 308 can be configured to determine a property of an analyte in a fluid, such as, e.g., a concentration of blood glucose in a sample of blood. Dual-powered electronic device 300 can include in addition to microcontroller 308 other circuitry (not shown) configured to perform or support various functions, such as, e.g., input/output, display, memory, and/or additional processing not provided by microcontroller 308. Microcontroller 308 and any other circuitry (not shown) of dual-powered electronic device 300 can represent the load of dual-powered electronic device 300 configured (as described herein) to receive power from either an external power source via USB connector 302 or non-rechargeable battery power source 310 via battery connector 306. Except for power source switching circuit 301, dual-powered electronic device 300, USB connector 302, voltage regulator 304, battery connector 306, microcontroller 308, and/or non-rechargeable battery power source 310 can be identical to respective dual-powered electronic device 100, USB connector 102, low dropout voltage regulator 104, battery connector 106, microcontroller 108 and/or non-rechargeable battery power source 110. Alternatively, dual-powered electronic device 300 can be any suitable dual-powered electronic device.

Power source switching circuit 301 can include a first power source input node 312, a second power source input node 314, and a system power node 316. First power source input node 312 can be coupled to USB connector 302 via voltage regulator 304 coupled there between. Voltage regulator 304 can be a low dropout voltage regulator. Second power source input node 314 can be coupled to positive terminal 318 of battery connector 306, and system power node 316 can be coupled to the load of dual-powered electronic device 300 (i.e., microcontroller 308 and other possible circuitry (not shown)).

Power source switching circuit 301 can also include a P-channel MOSFET 320, a voltage divider 334, and a comparator 336. P-channel MOSFET 320 can have a drain D, a source S, and a gate G. Drain D of P-channel MOSFET 320 can be coupled to second power source input node 314, and source S of P-channel MOSFET 320 can be coupled to system power node 316. Voltage divider 334 can have an input 338 coupled to first power source input node 312 and an output at output node 340. Comparator 336 can be a low-power embedded analog comparator commonly available for use in microcontroller 308. Alternatively, comparator 336 can be an integrated or discrete component outside of microcontroller 308 or can be available in another circuit component (not shown) of dual-powered electronic device 300. Comparator 336 can have a non-inverting input 342 coupled to output node 340 of voltage divider 334. Comparator 336 can also have an inverting input 344 coupled to second power source input node 314, and an output 346 coupled to the gate G of P-channel MOSFET 320 at node 348. In some embodiments, other suitable types of comparators can be used in power source switching circuit 301.

Voltage divider 334 can include a first resistor 350 and a second resistor 352 coupled in series, wherein output node 340 can be located there between. In particular, one end of first resistor 350 can be coupled to input 338, while the other end of first resistor 350 can be coupled to output node 340. One end of second resistor 352 can be coupled to output node 340, while the other end of second resistor 352 can be coupled to ground (i.e., negative terminal 330 of battery connector 306). The value of second resistor 352 can be a function of the value of first resistor 350, a voltage (VREG312) at first power source input node 312, and a forward voltage drop (VD332) of diode 332 as follows:

R352=R350×(VREG312−VD332)/VD332

Voltage divider 334 can scale the voltage (VREG312) received at first power source input node 312 for input to non-inverting input 342 of comparator 336. The division ratio of voltage divider 334 can be selected such that the voltage divider output voltage (VDIVIDER) at output node 340 can track the system voltage (VSYS316) at system power node 316, which can be, e.g., 3.3 volts.

Power source switching circuit 301 can further include a first capacitor 324, a pull-down resistor 326, a second capacitor 328, and a Schottky diode 332 (other suitable types of diodes can be used in some embodiments). First capacitor 324 can be coupled between second power source input node 314 and ground (i.e., negative terminal 330 of battery connector 306). Pull-down resistor 326 can be coupled between the gate G of P-channel MOSFET 320 at node 348 and ground, and second capacitor 328 can be coupled between system power node 316 and ground. In some embodiments, depending on the type of non-rechargeable battery power source 310 and/or load of dual-powered electronic device 300, first capacitor 324 and second capacitor 328 can each be about 10 μf and/or pull-down resistor 326 can be about 100 k ohms. Schottky diode 332 can be coupled between first power source input node 312 and system power node 316 as shown in FIG. 3, wherein the anode of diode 332 can be coupled to first power source input node 312 and the cathode of diode 332 can be coupled to system power node 316.

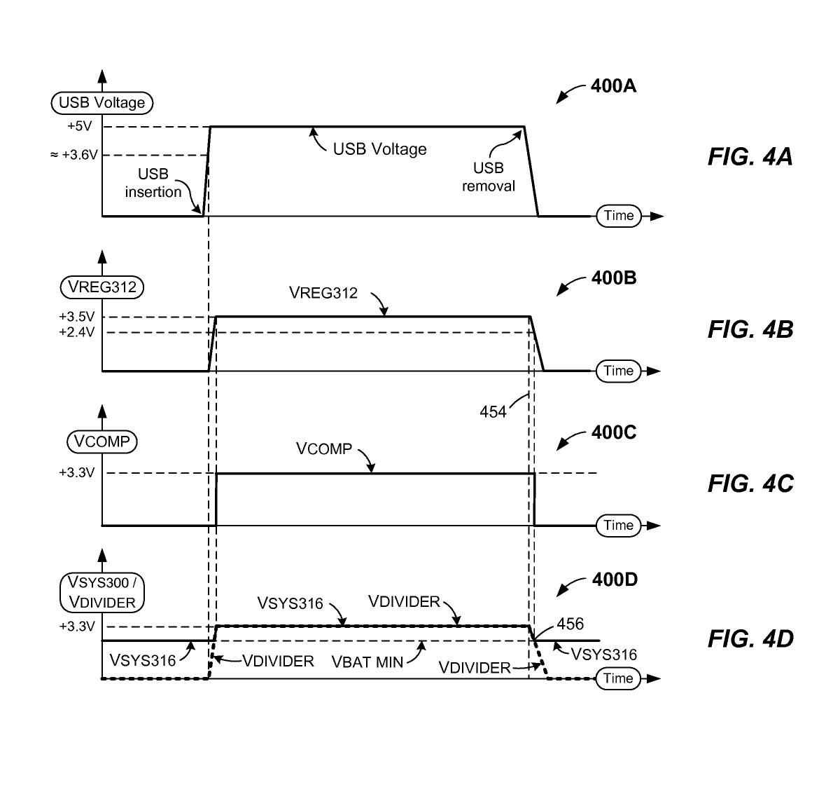

FIGS. 4A-D illustrate graphs of various voltages of dual-powered electronic device 300 versus time in accordance with one or more embodiments. In particular, FIG. 4A illustrates a waveform 400A of a USB voltage received at USB connector 302 from an external power source. In some embodiments, waveform 400A can be identical to waveform 200A of FIG. 2A. FIG. 4B illustrates a corresponding waveform 400B of a voltage (VREG312) at first power source input node 312 received from the output of voltage regulator 304, which can be a low dropout voltage regulator. FIG. 4C illustrates a corresponding waveform 400C of an output voltage (VCOMP) of comparator 336. And FIG. 4D illustrates a waveform 400D of a corresponding system voltage (VSYS316) at system power node 316 and a corresponding voltage (VDIVIDER) at output node 340 of voltage divider 334.

In standalone mode, wherein USB connector 302 is not coupled to an external power source (i.e., VREG312 at first power source input node 312 can be at or about zero volts), the voltage at non-inverting input 342 of comparator 336 can also be at or about zero volts. Concurrently, the voltage at inverting input 344 can be at battery voltage (VBAT314). These inputs can cause output 346 of comparator 336 to be LOW (e.g., at or about zero volts), which can cause pull-down resistor 326 to hold gate G of P-channel MOSFET 320 at ground level. This can maintain P-channel MOSFET 320 in a conductive state (i.e., P-channel MOSFET 320 is “ON”). Non-rechargeable battery power source 310 via battery connector 306 is thus electrically connected to system power node 316 via P-channel MOSFET 320 and, because P-channel MOSFET 320 can have very low DC resistance, VBAT314=VSYS316 at second power source input node 314 and system power node 316, respectively. Accordingly, non-rechargeable battery power source 310 can provide power in standalone mode to the load (i.e., the circuitry of dual-powered electronic device 300 including at least microcontroller 308), which is coupled to system power node 316.

Upon a user plugging one end of a USB cable into USB connector 302 and the other end into a USB port (of, e.g., a personal computer or suitable converter connected to a power outlet), a USB voltage of typically about 5 volts can be received at the input of voltage regulator 304, as shown shortly after “USB insertion” in FIG. 4A. Voltage regulator 304 can typically generate an output voltage (VREG312) of about 3.5 volts at first power source input node 312, as shown in FIG. 4B. The resulting system voltage (VSYS316) at system power node 316 can be about 3.3 volts.

To prevent damage to non-rechargeable battery power source 310 from power received via USB connector 302, power source switching circuit 301 can be configured to electrically disconnect battery connector 306 and non-rechargeable battery power source 310 from system power node 316. As soon as the voltage (VDIVIDER) at non-inverting input 342 of comparator 336 becomes more positive than the voltage (VBAT314) at inverting input 344 of comparator 336 (that is, e.g., 3.3 volts (VDIVIDER) versus 3.0 volts max (VBAT314)), the voltage (VCOMP) at output 346 of comparator 336 can be HIGH (e.g., at a voltage equal to or about VSYS316), as shown in FIG. 4C. In response thereto, the voltage at gate G of P-channel MOSFET 320 can also be HIGH (e.g., at a voltage equal to or about VSYS316), which can drive P-channel MOSFET 320 into a non-conductive state (i.e., P-channel MOSFET 320 can turn “OFF”), which electrically disconnects battery connector 306 and non-rechargeable battery power source 310 from system power node 316.

Upon removing the USB cable from the USB port and/or USB connector 302, the USB voltage can begin to drop as shown immediately after “USB removal” in FIG. 4A. In response to the USB voltage dropping below the minimum rated input voltage for voltage regulator 304 (which typically can be about 3.6 volts), VREG312 can also begin to drop as shown at time 454 in FIG. 4B. The dropping of voltage VREG312 can cause VSYS316 to drop as shown in FIG. 4D. Correspondingly, the voltage (VDIVIDER) at non-inverting input 342 of comparator 336 can also begin to drop as also shown in FIG. 4D. As soon as VDIVIDER/VSYS316 becomes less than the voltage (VBAT314) at inverting input 344 of comparator 336 (by only a few millivolts in some embodiments), the voltage (VCOMP) at output 346 of comparator 336 can become LOW (e.g., at ground level), as shown in FIG. 4C. In response thereto, the voltage at gate G of P-channel MOSFET 320 can also become LOW, which can drive P-channel MOSFET 320 into a conductive state (i.e., P-channel MOSFET 320 can turn “ON”). This can electrically re-connect battery connector 306 and non-rechargeable battery power source 310 to system power node 316. Non-rechargeable battery power source 310 can thus again provide power in standalone mode to the load of dual-powered electronic device 300.

As shown at time 456 in FIG. 4D, no transient voltage drop occurs in the system voltage (VSYS316) at system power node 316 during a power source transition from an external power source (providing power to first power source input node 312 via USB connector 302) to non-rechargeable battery power source 310 (providing power to second power source input node 314 via battery connector 306). Thus, dual-powered electronic device 300 can be powered by non-rechargeable battery power source 310 through a lower range of usable battery voltages provided by non-rechargeable battery power source 310 as compared to dual-powered electronic device 100. For example, in some embodiments, dual-powered electronic device 300 can operate with battery voltages below about 2.4 volts, provided that the battery voltage stays above the reset voltage threshold (VRESET), which typically can be about 1.8 volts.

Furthermore, power source switching circuit 301 can be configured to provide and maintain the system voltage (VSYS316) at system power node 316 above the reset voltage threshold of dual-powered electronic device 300 by coupling only one power source at a time to system power node 316. That is, power source switching circuit 301 is not configured to couple both an external power source and a non-rechargeable battery power source concurrently to system power node 316 in order to maintain system voltage VSYS316 above the reset voltage threshold during, e.g., power source transitions. In particular, power source switching circuit 301 only electrically couples non-rechargeable battery power source 310 to system power node 316 in response to removal of an external power source (via USB connector 302) from first power source input node 312.

In some embodiments, comparator 336 can operate in an ultra-low power mode, which can have a negligible effect on battery life. To further reduce the effect on battery life, comparator 336 can be disabled, in some embodiments, by software executing in microcontroller 308 when dual-powered electronic device 300 is in standalone mode. In response to detection of an external power source coupled to dual-powered electronic device 300 at USB connector 302, microcontroller 308 can enable comparator 336. In response to removal of the external power source from USB connector 302 and reconnection of non-rechargeable battery power source 310, microcontroller 308 can again disable comparator 336.

In other embodiments, power source switching circuit 301 can alternatively include other suitable types of FETs (field effect transistors) or power source switches instead of P-channel MOSFET 320. For example, a suitable N-channel MOSFET can be used in some embodiments, wherein the suitable N-channel MOSFET can be used to electrically connect and disconnect a non-rechargeable battery power source via a negative terminal of a battery connector. In other embodiments, a suitable switch can be used in place of P-channel MOSFET 320. Such a switch can be coupled between second power source input node 314 and system power node 316 and can be configured to be open in response to first power source input node 312 receiving an operating voltage from an external power source via USB connector 302, and closed in response to first power source input node 312 not receiving the operating voltage from the external power source.

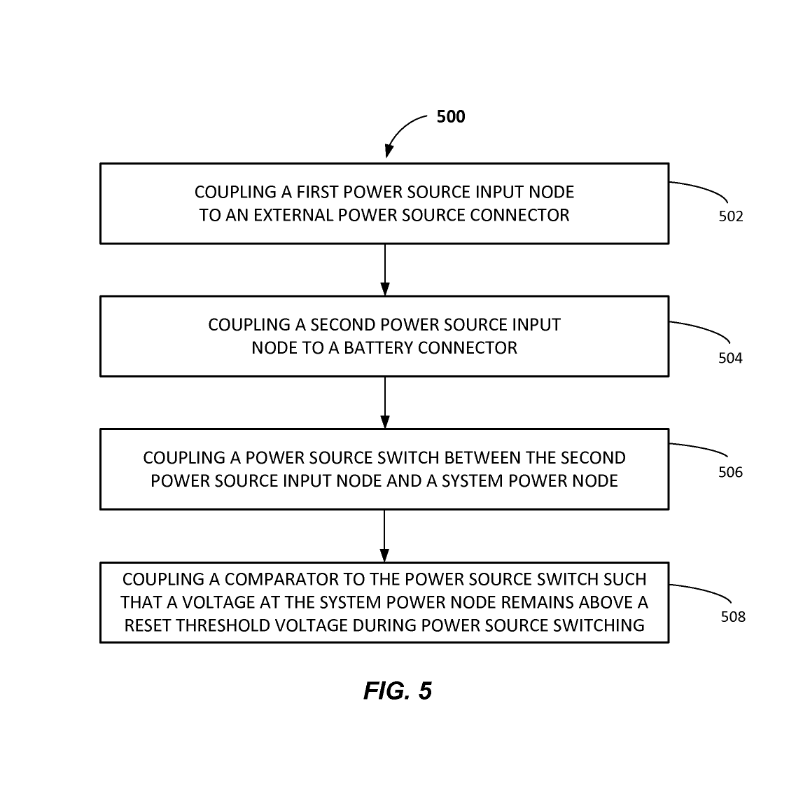

FIG. 5 illustrates a method 500 of providing a power source switching circuit for a dual-powered electronic device. In some embodiments, the dual-powered electronic device can be a blood glucose meter. At process block 502, method 500 can include coupling a first power source input node of the power source switching circuit to an external power source connector of the dual-powered electronic device. For example, the power source switching circuit can be power source switching circuit 301, the first power source input node can be first power source input node 312, and the external power source connector can be USB connector 302, all of FIG. 3. In some embodiments, a voltage regulator, such as voltage regulator 304 of FIG. 3, can be connected between the external power source connector and the first power source input node.

At process block 504, method 500 can include coupling a second power source input node of the power source switching circuit to a battery connector of the dual-powered electronic device. For example, the second power source input node can be second power source input node 314 of FIG. 3, and the battery connector can be battery connector 306 of FIG. 3. In some embodiments, the battery connector can be configured to receive and connect to one or more Li—Mn type batteries, such as, e.g., one or more CR2032 coin cell batteries.

At process block 506, a power source switch can be coupled between the second power source input node and a system power node of the dual-powered electronic device. In some embodiments, the power source switch can be an FET (field effect transistor), and in particular, a P-channel FET, and more particularly, a P-channel MOSFET (metal-oxide-semiconductor-field-effect transistor). For example, the power source switch can be P-channel MOSFET 320 of FIG. 3. In other embodiments, other suitable switches and/or transistor devices can be used. The system power node can be, e.g., system power node 316 of FIG. 3, wherein system power node 316 can be coupled to source S of P-channel MOSFET 320, and the second power source input node (e.g., second power source input node 314) can be coupled to drain D of P-channel MOSFET 320.

At process block 508, method 500 can include coupling a comparator to the power source switch such that a voltage at the system power node remains above a reset voltage threshold during power source switching. More particularly, in some embodiments, method 500 can include at process block 508 coupling a comparator to the power source switch such that the comparator controls the connect and disconnect operation of the power source switch, wherein the comparator is configured to cause the power source switch to conductively connect the second power source input node to the system power node such that a voltage at the system power node maintains a voltage level above a reset voltage threshold of the dual-powered electronic device during a transition from the first power source input node receiving an operating voltage via the external power source connector to the first power source input node not receiving the operating voltage. In some embodiments, the output of the comparator can be configured to be HIGH in response to the first power source input node receiving an operating voltage from the external power source, and can be configured to be LOW in response to the first power source input node not receiving the operating voltage from the external power source. An operating voltage can be defined as a voltage of sufficient magnitude to properly drive the load of a dual-powered electronic device.

In those embodiments wherein the power source switch is an FET, the output of the comparator can be configured to drive the FET into a non-conductive state, which conductively disconnects the second power source input node from the system power node, in response to the first power source input node receiving the operating voltage from the external power source. In response to the first power source input node not receiving the operating voltage from the external power source, the output of the comparator can be configured to drive the FET into the conductive state, which conductively connects the second power source input node to the system power node.

In some embodiments, the comparator of method 500 can be comparator 336 of FIG. 3 which, in some embodiments, can be an embedded analog ultra-low power comparator of microcontroller 308.

The above process blocks of method 500 can be executed or performed in an order or sequence not limited to the order and sequence shown and described. For example, in some embodiments, process block 502 can be performed simultaneously with or after process blocks 504 and/or 506.

Persons skilled in the art should readily appreciate that the invention described herein is susceptible of broad utility and application. Many embodiments and adaptations of the invention other than those described herein, as well as many variations, modifications, and equivalent arrangements, will be apparent from, or reasonably suggested by, the invention and the foregoing description thereof, without departing from the substance or scope of the invention. For example, although described in connection with dual-powered electronic devices having a non-rechargeable battery power source, one or more embodiments of the invention may be used with other types of dual-powered electronic devices that use a power source switching circuit to electrically connect and disconnect one of the power sources, regardless of whether that one power source is a non-rechargeable battery power source or not. Accordingly, while the invention has been described herein in detail in relation to specific embodiments, it should be understood that this disclosure is only illustrative and presents examples of the invention and is made merely for purposes of providing a full and enabling disclosure of the invention. This disclosure is not intended to limit the invention to the particular apparatus, devices, assemblies, systems or methods disclosed, but, to the contrary, the intention is to cover all modifications, equivalents, and alternatives falling within the scope of the invention.

What is claimed is:

1. A power source switching circuit, comprising:
a first power source input node;
a system power node coupled to the first power source input node;
a second power source input node;
an FET (field effect transistor) having a gate, a drain, and a source, the drain coupled to the second power source input node, and the source coupled to the system power node;
a voltage divider having an input and an output, the input coupled to the first power source input node; and
a comparator having an output, a first input, and a second input, the output of the comparator coupled to the gate of the FET, the first input coupled to the output of the voltage divider, and the second input coupled to the second power source input node; wherein:
the FET is configured to be in a non-conductive state in response to the first power source input node receiving an operating voltage from an external power source, and in a conductive state in response to the first power source input node not receiving the operating voltage from the external power source.

2. The power source switching circuit of claim 1, wherein a voltage at the system power node maintains a voltage level above a reset voltage threshold during a transition from the first power source input node receiving the operating voltage to the first power source input node not receiving the operating voltage.

3. The power source switching circuit of claim 1, wherein the output of the comparator drives the FET into the non-conductive state in response to the first power source input node receiving the operating voltage from the external power source, and the output of the comparator drives the FET into the conductive state in response to the first power source input node not receiving the operating voltage from the external power source.

4. The power source switching circuit of claim 1, wherein the first input of the comparator comprises a non-inverting input and the second input of the comparator comprises an inverting input.

5. The power source switching circuit of claim 1, wherein the comparator is embedded in a microcontroller.

6. The power source switching circuit of claim 1, wherein the FET comprises a P-channel MOSFET (metal-oxide-semiconductor-field-effect-transistor).

7. The power source switching circuit of claim 1, wherein the voltage divider comprises first and second resistors coupled in series, the output of the voltage divider is a node between the first and second resistors, and a value of the second resistor is a function of the first resistor value, a voltage at the first power source input node, and a forward voltage drop of a diode.

8. The power source switching circuit of claim 1, further comprising:
a USB (universal serial bus) connector coupled to the first power source input node; and
a battery connector coupled to the second power source input node.

9. A dual-powered electronic device, comprising:
an external power source connector;
a battery connector;
a load configured to receive power via the external power source connector or the battery connector; and
the power source switching circuit of claim 1; wherein:
the first power source input node is coupled to the external power source connector;
the second power source input node is coupled to the battery connector; and
the system power node is coupled to the load.

10. A dual-powered biosensor meter, comprising:
a USB (universal serial bus) connector;
a battery connector;
a microcontroller configured to receive power via the USB connector or the battery connector but not both concurrently, the microcontroller configured to determine a property of an analyte in a fluid; and
a power source switching circuit, comprising:
a first power source input node coupled to the USB connector;
a system power node coupled to the first power source input node and to the microcontroller;
a second power source input node coupled to the battery connector;
a switch coupled between the second power source input node and the system power node; and
a comparator configured to control the switch and having an output, a first input, and a second input, the output of the comparator coupled to the switch, the first input coupled to the first power source input node, and the second input coupled to the second power source input node; wherein:
the switch is configured to be open in response to the first power source input node receiving an operating voltage from an external power source via the USB connector, and closed in response to the first power source input node not receiving the operating voltage from the external power source; and
a voltage at the system power node maintains a voltage level above a reset voltage threshold during a transition from the first power source input node receiving the operating voltage to the first power source input node not receiving the operating voltage.

11. The biosensor meter of claim 10, wherein the switch comprises a P-channel MOSFET (metal-oxide-semiconductor-field-effect-transistor) having a gate, a drain, and a source, the gate coupled to the output of the comparator, the drain coupled to the second power source input node, and the source coupled to the system power node; wherein the P-channel MOSFET is configured to be in a non-conductive state in response to the first power source input node receiving the operating voltage from the external power source, and in a conductive state in response to the first power source input node not receiving the operating voltage from the external power source.

12. The biosensor meter of claim 10, further comprising a voltage regulator coupled between the USB connector and the first power source input node.

13. The biosensor meter of claim 10, further comprising a voltage divider having an input and an output, the input coupled to the first power source input node and the output coupled to the first input of the comparator.

14. A method of providing a power source switching circuit for a dual-powered electronic device, the method comprising:
coupling a first power source input node of the power source switching circuit to an external power source connector of the dual-powered electronic device;
coupling a second power source input node of the power source switching circuit to a battery connector of the dual-powered electronic device;
coupling a power source switch between the second power source input node and a system power node of the dual-powered electronic device; and
coupling an output of a comparator to the power source switch such that the comparator controls the connect and disconnect operation of the power source switch, wherein the comparator is configured to cause the power source switch to conductively connect the second power source input node to the system power node such that a voltage at the system power node maintains a voltage level above a reset voltage threshold of the dual-powered electronic device during a transition from the first power source input node receiving an operating voltage via the external power source connector to the first power source input node not receiving the operating voltage.

15. The method of claim 14 further comprising:
coupling a non-inverting input of the comparator to receive a voltage based on a voltage received at the first power source input node; and
coupling an inverting input of the comparator to the second power source input node.

16. The method of claim 14 further comprising coupling an input of a voltage divider to the first power source input node and coupling an output of the voltage divider to a first input of the comparator.

17. The method of claim 14, further comprising coupling an anode of a diode to the first power source input node and coupling a cathode of the diode to the system power node.

18. The method of claim 14, further comprising configuring the comparator to control the connect and disconnect operation of the power source switch such that an operating voltage is provided at the system power node via the first power source input node or the second power source input node, but not via both concurrently.

19. The method of claim 14, further comprising providing a P-channel FET (field effect transistor) as the power source switch.

20. The method of claim 14, wherein the dual-powered electronic device comprises a blood glucose meter.
